(19) United States
(12) Patent Application Publication
(10) Pub. No.: US 2002/0127343 A1
(43) Pub. Date: Sep. 12, 2002

(54) Methods and apparatus for forming a graded fade zone on a substrate and articles produced thereby

(76) Inventors: Luke A. Kutilek, Oakmont, PA (US); Roger L. Scriven, Gibsonia, PA (US)

Correspondence Address: Donald C. Lepiane, Esq., PPG INDUSTRIES, INC., One PPG Place, Pittsburgh, PA, 15272, US

(21) Appl. No.: 10/007,979

(22) Filed: Nov. 13, 2001

Related U.S. Application Data
(63) Continuation-in-part of application No. 09/270,701, filed on Mar. 17, 1999, now abandoned.
Application No. 09/270,701 is a continuation-in-part of application No. 08/992,484, filed on Dec. 18, 1997, now Pat. No. 6,312,790.
(60) Provisional application No. 60/096,415, filed on Aug. 13, 1998.

(51) Int. Cl. B05D 3/02; B05D 1/02

(52) U.S. Cl. 427/420; 427/256; 427/421; 427/314

(57) ABSTRACT

An apparatus for forming a graduated coating on a substrate includes a coating station positioned along a conveyor. The coating station includes a first coating dispenser pivotally mounted on a first support and at least one exhaust hood. The first coating dispenser is positioned such that an axis through the delivery end of the first coating dispenser subtends the substrate at a predetermined angle. A method for forming a graduated fade zone on a substrate surface includes positioning a coating dispenser adjacent one side of the substrate, angling the coating dispenser toward the other side of the substrate and supplying a coating material to the coating dispenser such that the coating material is deposited onto the substrate to form a graded fade zone on the substrate.

### CROSS REFERENCE TO RELATED APPLICATIONS

This application is a continuation-in-part of U.S. patent application Ser. No. 09/270,701 filed Mar. 17, 1999, which was a continuation-in-part of U.S. patent application Ser. No. 08/992,484 filed on Dec. 18, 1997, which claimed the benefits of U.S. Provisional Application Serial No. 60/096,415, filed on Aug. 13, 1998. The disclosures of all of the above applications are herein incorporated by reference in their entirety.

### BACKGROUND OF THE INVENTION

1. Field of the Invention

The invention relates generally to methods and apparatus for coating an article, e.g., a float glass ribbon and, more particularly, for selectively positioning coating dispensers relative to a heated substrate to deposit a spray of aqueous suspensions of organometallic compounds onto the substrate to pyrolytically coat a graded fade zone on the surface of a substrate.

2. Description of the Presently Available Technology

In various industrial applications, such as in the fabrication of automotive transparencies, it is desirable to have coated areas known as “shade bands” or “fade zones” on the automotive transparencies. These coated areas may be used to decrease solar energy transmittance, e.g., to reduce visible, infrared or ultraviolet light transmittance to reduce heat gain in the interior of the vehicle and also to improve occupant, especially driver, visibility under circumstances of glare. The term “fade zone” generally refers to a band adjacent the edge of the transparency e.g. the top edge of an automotive windshield in which the visibility through the transparency changes from a less transparent area to a more transparent area.

Various devices and methods are known for applying graduated or graded coatings onto a substrate. For example, U.S. Pat. No. 2,676,114 to Barkley discloses the use of a plurality of stationary shields geometrically positioned with respect to a plurality of evaporation coating sources to form a series of adjacent, discrete coating bands of different thicknesses on the substrate. A limitation of the technique is the discrete coating bands giving the coated substrate an aesthetically displeasing banded or striped appearance.

U.S. Pat. No. 3,004,875 to Lytle discloses a device for applying a graded coating band along the edge of a substrate. The device includes a plurality of spray guns located above a shield. The resulting band has a thicker area located remote from the spray guns and a thinner area adjacent the spray guns. Limitations of this technology are the device requiring a complex shielded spray arrangement and the resulting band having a mottled appearance due to eddies that evolve beneath the shield near the shield edge during the coating operation.

U.S. Pat. No. 4,138,284 to Postupack discloses applying a dye composition along one edge of a glass substrate. The resultant band has a relatively wider area of substantially uniform thickness with a narrow, graded boundary portion located between the coated and uncoated portions of the substrate. An electrostatic spray gun is located above a grounded shield which covers a portion of the substrate which is not to be coated. A manifold located below the shield moves fluid toward the edge of the shield to reduce the effect of eddies formed under the shield and to produce a narrow coated graded portion below the outer edge of the shield. A limitation of this technology is the device requiring complex and expensive electrostatic spray guns and charged shields.

As will be appreciated by those skilled in the art, it would be advantageous to provide methods of and apparatus for applying a graded coating over a substrate surface that does not have the limitations of the presently available methods and apparatus.

### SUMMARY OF THE INVENTION

This invention relates to an apparatus for forming a graded coating on a surface of a substrate, for example a piece of glass, such as a float glass ribbon. The apparatus includes a coating station and facilitates for moving the glass piece relative to one another. The coating station includes a coating dispenser mounted, e.g., pivotally or non-pivotally mounted, on a first support. An exhaust hood is mounted on one or both sides of the coating dispenser. A source of coating material and a source of pressurized fluid are in flow communication with the coating dispenser. The coating dispenser is mounted relative to the glass moving facilities such that an imaginary axis through the delivery orifice, e.g., the nozzle or center line of the expected coating spray if more than one nozzle is used, of the coating dispenser intersects the glass moving facilities at a predetermined angle such that the coating spray exiting the delivery end of the coating dispenser provides a graded coating on the glass surface. The graded coating is thicker near the delivery end of the coating dispenser and thinner farther from the delivery end of the coating dispenser. Preferably the coating thickness has a uniform decrease as the distance from the delivery end of the coating dispenser or the edge of the glass piece near the coating dispenser increases.

The apparatus may include a second coating dispenser pivotally mounted on a second support. One or both the coating dispensers may be vertically and horizontally movable.

In the instance when a heated glass is to be coated, the glass moving facilities, e.g., a conveyor, transports the glass piece from a heated chamber into the coating station.

In a further embodiment of the invention, the apparatus includes a plurality of spaced apart coating dispensers or nozzles positioned in alignment or off-set from one another over the surface of the substrate to be coated. Each coating dispenser dispenses a cone or fan-shaped spray, e.g., an elliptical pattern, of coating material onto a surface portion of the substrate. The coated area from one nozzle overlaps a coated area from another nozzle to form a coating having a substantially uniformly thick center region with graded regions located on each side of the center region.

The invention further relates to a method of forming a fade zone on a surface of the substrate by positioning a coating dispenser adjacent a side of the substrate and angling the coating dispenser toward the opposite side of the substrate such that coating material dispensed from the coating dispenser is deposited onto the substrate as a graded fade zone. Preferably, in the practice of the invention, an organometallic material which pyrolytically forms a coating is used.

Still further, the invention relates to an article of manufacture, e.g. an architectural window or an automotive transparency having a graded, pyrolytically deposited coating over a portion of a substrate surface.

### BRIEF DESCRIPTION OF THE DRAWINGS

FIG. 1 is an isometric view of a coating station embodying features of the invention;

FIG. 2 is an isometric view of an alternative embodiment of the coating station of the invention;

FIG. 3 is a block diagram of a float glass making apparatus having a coating station of the invention;

FIG. 4 is a side, sectional view of a substrate coated by the coating station of the invention to form a graded fade zone;

FIG. 5 is a bottom view of a CVD coater incorporating the teachings of the invention;

FIG. 6 is a perspective view of an additional coating apparatus embodiment of the invention;

FIG. 7 is a plan view of a coating pattern formed by the apparatus shown in FIG. 6;

FIG. 8 is an end, sectional view of a substrate coated by the coating apparatus of FIG. 6;

FIGS. 9 and 10 are graphs of the percent reflectance and transmittance across the width of coated glass pieces produced by the coating apparatus of FIG. 6; and

FIG. 11 is an isometric view of a vehicle having windows formed by glass substrates coated in accordance with the invention.

### DESCRIPTION OF THE PREFERRED EMBODIMENTS

For purposes of the description hereinafter, the terms “near”, “far”, “right”, “left”, “vertical”, “horizontal”, “top”, “bottom”, “above”, “below” and derivatives thereof shall relate to the invention as it is oriented in the figures. It is to be understood, however, that the invention may assume various alternative variations and step sequences, except where expressly specified to the contrary. It is also to be understood that the specific apparatus and processes illustrated in the figures, and described in the following specification, are simply exemplary embodiments of the invention. Hence, specific dimensions and other physical characteristics related to the embodiments disclosed herein are not to be considered as limiting to the invention. Further, as used herein, all numbers expressing dimensions, physical characteristics, processing parameters, quantities of ingredients, reaction conditions, and the like used in the specification and claims are to be understood as being modified in all instances by the term “about”. Accordingly, unless indicated to the contrary, the numerical values set forth in the following specification and claims are approximations that may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 5.5 to 10. The terms “flat” or “substantially flat” refer to a surface or a substrate that is substantially planar in form, that is a primarily level surface or substrate lying in a single geometric plane.

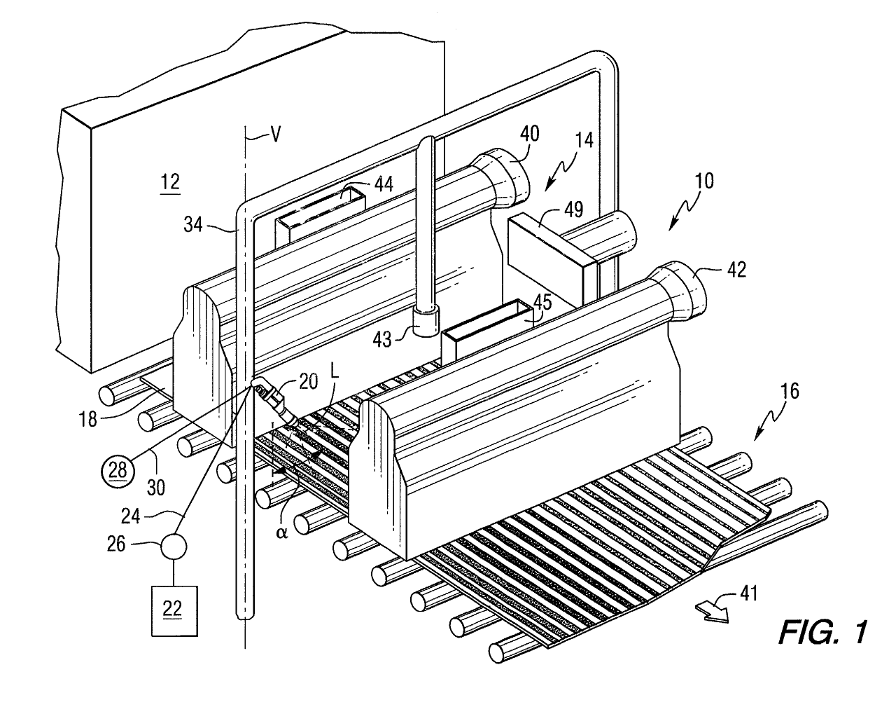

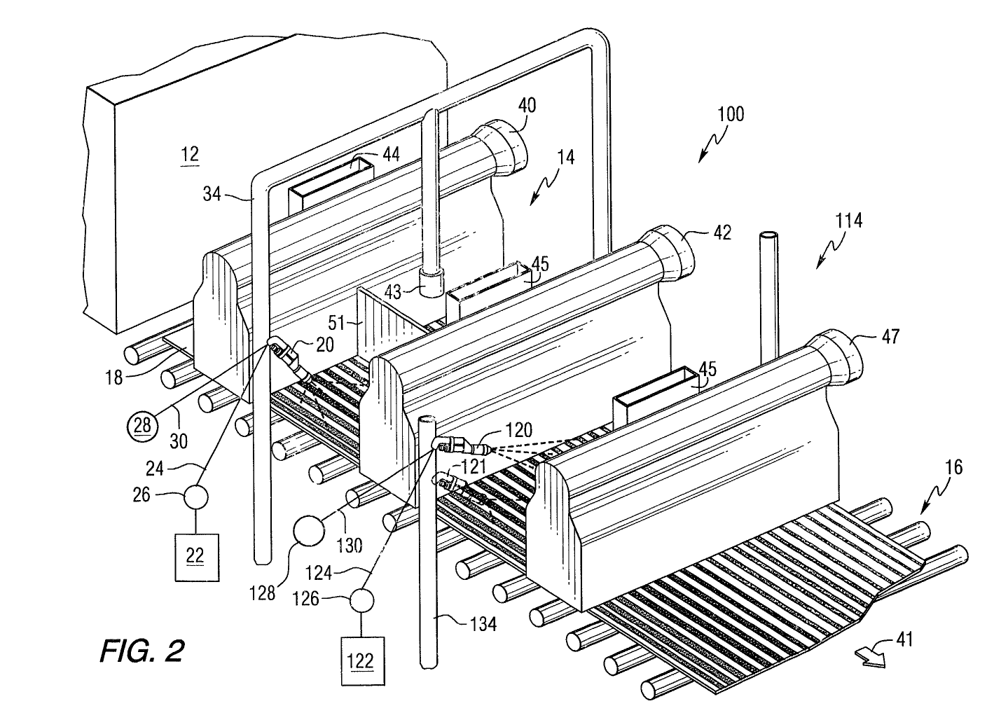

With reference to FIG. 1, there is shown an exemplary coating apparatus 10 incorporating features of the invention. The coating apparatus 10 includes a coating station 14 for depositing a graded coating on a substrate. In FIGS. 1 and 2, the graded coating of the invention is represented by spaced lines of decreasing thickness. However, it is to be understood that this representation is symbolic only, and in actuality, the coating of the invention has a non-banded, graded appearance. In the discussion of the invention, although not limiting thereto, a pyrolytic coating is deposited on a heated substrate. Therefore, in the following discussion, a heated chamber, e.g., furnace 12, and a conveyor 16 are utilized with the coating station 14. The conveyor 16 extends from the furnace 12 through the coating station 14 and is configured to transport a substrate 18, e.g., a piece of flat glass to be coated or a float glass ribbon, from the furnace 12 through the coating station 14 at a selected speed. The conveyor 16 can be of any conventional type, such as a plurality of rotatable metal or ceramic rolls.

The coating station 14 includes a coating dispenser 20, such as a conventional air-atomizing Binks-Sames Model 95 spray nozzle. The coating dispenser 20 is configured to spray an atomized liquid material in a fan or cone-shaped pattern toward a surface of the substrate 18 in the coating station 14. The coating dispenser 20 is in flow communication with a source 22 of coating material, preferably an aqueous suspension of one or more metal acetylacetonates or other conventional coating materials, by a flexible conduit 24. Suitable coating materials are disclosed, for example, in U.S. Pat. No. 4,719,127 to Greenberg, which disclosure is herein incorporated by reference. A metering pump 26, such as a conventional Cole-Parmer MasterFlex 07523-20 pump, is in flow communication with the conduit 24. The coating dispenser 20 is also in flow communication with a source 28 of compressed fluid, such as air, by a flexible conduit 30.

The coating dispenser 20 may be stationary or nonmovably mounted on a support, i.e., the dispenser may not move during the coating operation. Alternatively, in one embodiment, the coating dispenser 20 is mounted for pivotal, lateral and vertical movement in any usual manner on a support 34, such as a metal frame. The coating dispenser 20 can be mounted relative to the glass piece to be coated or the supporting surface of the conveyor 16 such that an angle α (e.g., an oblique angle as shown in FIG. 1) of between about 0-90°, such as between about 20-40°, is formed between an imaginary axis or line L drawn through the center of the spray emitting from the nozzle or discharge end of the coating dispenser 20 and a vertical axis V extending substantially perpendicular to the supporting surface or the surface of the substrate 18 being coated. The coating dispenser 20 is also vertically and horizontally movable such that the height of the coating dispenser 20 above the conveyor 16 as well as the position of the dispenser 20 along the conveyor 16 and the lateral position of the coating dispenser 20 with respect to the conveyor 16 can be selectively fixed. While only one coating dispenser 20 is shown in FIG. 1, a plurality of such coating dispensers 20 can be located at the first coating station, e.g., on the first support 34, for example, beside, over or under the first coating dispenser 20.

A first exhaust hood 40 is located upstream of the coating dispenser 20 with respect to direction of travel of the conveyor 16 as indicated by arrowed line designated by the numeral 41, and a second exhaust hood 42 is located downstream of the coating dispenser 20 with respect to direction of travel of the conveyor 16. Optionally, a temperature sensor 43, such as a conventional infrared thermometer, may be positioned above the conveyor 16 adjacent the first exhaust hood 40 to sense the temperature of the substrate 18 for pyrolytic coating. Each exhaust hood 40 and 42 is in flow communication with a respective exhaust conduit 44 or 45. An auxiliary exhaust hood 49 may be located near the far side of the substrate 18 away from the coating dispenser 20 to provide additional exhaust capability. To avoid an unwanted overspray onto the glass surface, a barrier 51 shown in FIG. 2 may be provided and/or the hood 49 may be used. In this manner, any randomly airborne coating materials will be prevented from being carried and deposited on the uncoated portion of the glass to eliminate, reduce, or minimize unwanted overspray.

With continued reference to FIG. 2 there is shown a coating apparatus 100 incorporating features of the invention. The coating apparatus 100 includes a second coating station 114 having a second coating dispenser 120 mounted, e.g., either movably or non-movably mounted, on a second support 134. A third exhaust hood 47 is located downstream of the second exhaust hood 42. Although not shown in FIG. 2, an auxiliary exhaust hood 49 as shown in FIG. 1 may also be located in the first and/or second coating stations 14 and 114, respectively. The second support 134 is laterally spaced from the first support 34 so that the second coating dispenser 120 is located between the second and third exhaust hoods 42 and 47. As shown in dashed lines in FIG. 2, additional coating dispensers 121 may be located at the second coating station 114, for example, beside, over or under the second coating dispenser 120. In both the apparatus 10 and 100, no shield or deflector is located between the spray from the coating dispensers and the object being coated so that the spray is not blocked or impeded but rather has a free, unrestricted path to the substrate.

The second coating dispenser 120 may be in flow communication with the source 28 of compressed fluid and the source 22 of coating material of the first coating dispenser 20 to spray the same coating material onto the substrate 18. Alternatively, as shown in FIG. 2, the second coating dispenser 120 may be in flow communication with a separate source 128 of compressed fluid by a conduit 130 and a separate source 122 of coating material by a conduit 124 having a metering pump 126 to spray the same or a different coating onto the substrate 18. The additional coating dispenser 121 may similarly be in flow communication with the same or different sources of compressed fluid and coating material as the coating dispensers 20 and 120. The imaginary lines drawn through the discharge ends of the coating dispensers 20 and 120 may subtend different angles with respect to the substrate.

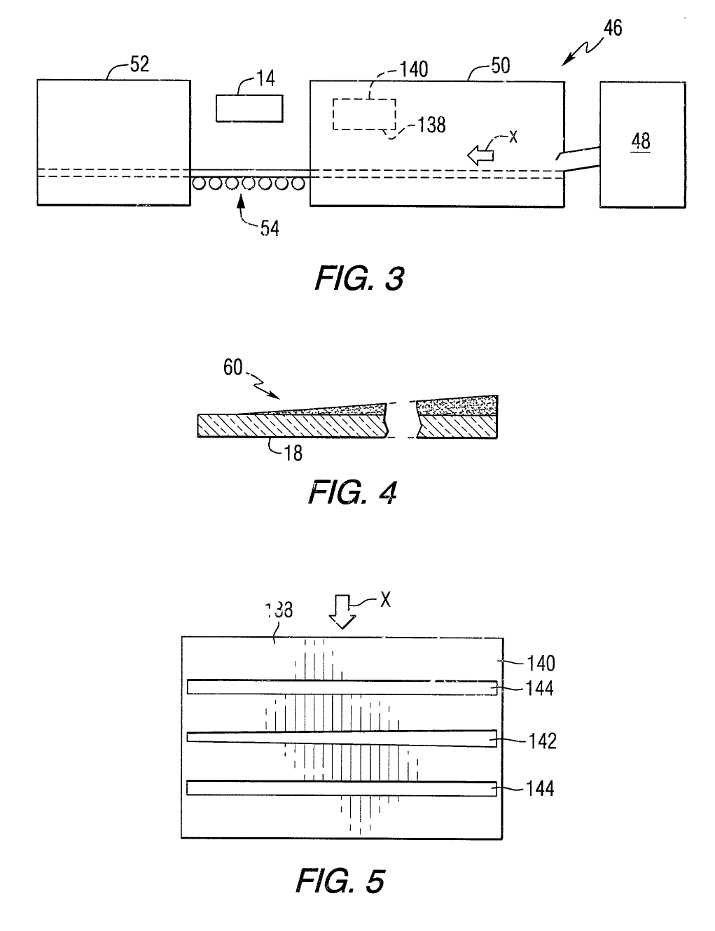

FIG. 3 shows a conventional float glass system 46 embodying features of the invention. As will be readily understood by one of ordinary skill in the art of float glass making, a conventional float glass system 46 includes a furnace 48 in which molten glass is formed. The molten glass is then transferred onto a molten metal bath contained in a forming chamber 50 to form a glass ribbon on the metal bath surface. The glass ribbon exits the chamber 50 and moves into an apparatus, e.g., an annealing lehr 52, by way of a conveyor 54 for controlled cooling of the glass. As shown in FIG. 3, a coating station, e.g., coating station 14 of FIG. 1 or the tandem coating station 100 of FIG. 2, can be positioned between the chamber 50 and the annealing lehr 52. Moreover, either before entering the lehr 52 or after the controlled cooling process is complete, the ribbon may be cut into discrete pieces and/or shaped or bent to a desired configuration or contour in any conventional manner.

Operation of the coating station 14 will now be described with particular reference to the embodiment shown in FIG. 1. In the following discussion, the heating chamber or furnace 12 of FIG. 1 may be considered the chamber 50 of FIG. 3 for a continuous piece of glass, e.g., a glass ribbon, or as a conventional furnace for individual glass pieces.

A continuous substrate, e.g., a glass ribbon, or discrete substrates 18 to be coated, such as pieces of flat glass, are heated to a desired temperature in the chamber 50 or the furnace 12, respectively. The conveyor 16 transports the heated substrates 18 into the coating station 14. The coating dispenser 20 is selectively positioned at a desired height and lateral position, i.e., distance from the side of the conveyor 16, and at an angle a such that when the substrate 18 is transported through the coating station 14, the coating dispenser 20 directs the coating material onto the upper surface of the substrate 18. This positioning of the coating dispenser 20 can be done either manually or automatically by a conventional automated positioning device attached to the coating dispenser 20. In one embodiment, the coating is applied in a single pass, e.g., the substrate is moved past the dispenser only once to apply the coating. In one embodiment, the gradient coating of the invention can be obtained in the practice of the invention using a single dispenser and one coating pass.

As the substrate 18 moves through the coating station 14, coating material is moved from the coating material source 22 to the coating dispenser 20 and mixed with compressed air from the compressed fluid source 28 to exit the nozzle of the coating dispenser 20 as a cone-shaped spray pattern of coating material directed toward the hot substrate 18. The first and second exhaust hoods 40 and 42 exhaust excess coating material from the coating station 14 to provide an essentially defect or blemish free uniform coating. The auxiliary exhaust hood 49 may also be used to further enhance the exhaust from the coating station 14. As discussed above, to prevent coating particles in the air from moving over and depositing on the portion of the ribbon furthermost from the coating dispenser, a barrier 51 shown only in FIG. 2 may be used. As the substrate 18 moves through the coating station 14, the coating dispenser 20 sprays the coating material onto the top of the hot substrate 18, where the coating material pyrolyzes to form a substantially durable graded pyrolytic coating. In one embodiment, the substrate is a glass ribbon and the coating material is applied onto a major surface, e.g., the top surface, of the ribbon which lies in a horizontal or substantially horizontal plane. By “horizontal plane” is meant a plane extending substantially perpendicular to the vertical axis V (see FIG. 1). Thus, the coating material can be deposited on the flat or substantially flat top surface of the glass ribbon as it moves past the coating dispenser, e.g., in a single pass.

The size of the spray fan as measured at the glass surface, the speed of the conveyor 16 and the distance between the nozzle of the coating dispenser 20 and the substrate 18 are fixed such that the spray pattern forms a desired coating distribution or grade on top of the substrate 18. Coating pressures and volumes through the coating dispenser 20 are selectively controlled to deposit a desired coating gradient and thickness on the surface of the substrate 18. Because the coating dispenser 20 is angled toward the far side of the substrate 18, a thicker layer of the coating material is deposited on the near side of the substrate 18, i.e., the side of the substrate closest to the coating dispenser 20, and a thinner layer of coating material is deposited on the substrate 18 as the distance of the substrate surface from the coating dispenser increases, with a substantially continuous thickness gradient occurring therebetween, i.e., as the distance from the coating dispenser 20 increases, the coating thickness decreases. With reference to FIG. 4, a smooth, substantially continuously graded coating material 60 is deposited across a desired width of the upper surface of the substrate 18. Since no shields or deflectors to intersect or interfere with the spray e.g. of the type common in the prior art are required to practice the invention, the resulting coating forms a smooth, continuous gradient on the substrate 18 without the banding or mottling limitations common with prior art coating devices. The coating material exiting from the dispenser has a free, unrestricted path from the dispenser to the substrate surface, i.e., there are no shields or barriers to restrict or interfere with the flow of the coating material. Also, by using a pyrolytic coating material rather than the dyes common in the prior art, the resulting coated substrate of the invention can be directly utilized, e.g., as an automotive transparency, without the need for additional protective measures such as protective overcoats or lamination generally required for the dye coated substrates of the prior art.

As will be understood by one of ordinary skill in the art of glass coating, the coating system parameters may affect the resulting coating. For example, all else remaining equal, the faster the substrate 18 is moved through the coating station, the thinner will be the overall thickness of the coating. The larger the angle α, the thinner will be the coating near the coating dispenser 20 and the thicker will be the coating farther away from the coating dispenser 20. As the distance of the coating dispenser 20 above the substrate 18 increases, the thinner will be the overall coating. The larger the flow rate of coating material through the coating dispenser 20, the thicker will be the overall coating.

### EXAMPLE

Pieces of flat glass (commercially available from PPG Industries, Inc. of Pittsburgh, Pennsylvania under the registered trademark SOLARBRONZE®) approximately 0.157 inch (4.0 mm) thick, 24 inches (60.1 cm) wide and 30 inches (76.2 cm) long were coated with the coating station of the invention shown in FIG. 1. The glass substrates were preheated in an electric horizontal roller hearth furnace with a furnace temperature of about 1150° F. (621° C.). The heated substrates were transported by the conveyor from the furnace through the coating station at a line speed of about 250 inches (635 cm) per minute. The temperature of the substrates entering the coating station was about 1135-1139° F. (613-615° C.), as measured by the infrared thermometer 43 positioned above the conveyor just upstream of the first exhaust hood 40. The coating material used was an aqueous suspension of a mixture of finely ground metal acetylacetonates mixed in water at 16.5 wt % and having a specific gravity of 1.025 measured at 72° F. (22° C.). The metal acetylacetonate mixture consisted of 95 wt % cobaltic acetylacetonate Co(C₅H₇O₂)₃ and 5 wt % ferric acetylacetonate Fe(C₅H₇O₂)₃ The aqueous suspension was placed in a container having an impeller type mixer operated at 352 rpm to maintain the suspension. The liquid suspension was delivered to the spray nozzle by a laboratory peristaltic metering pump (Cole-Parmer MasterFlex 07523-20) at a rate of 85 milliliters per minute. The spray nozzle was a conventional air-atomizing type (Binks-Sames model 95) and compressed air was utilized at a pressure of 50 lbs. per square inch, gauge (3.5 kg/sq. cm). The spray nozzle was laterally positioned about 7 inches (17.8 cm) from the near side of the substrate and was vertically positioned about 11 inches (27.9 cm) above the surface of the glass substrate to be coated. The spray nozzle was angled such that a centerline of the nozzle intersected the top of the substrate at an angle α of about 25°. This arrangement produced a graduated, substantially bronze colored fade zone on the glass substrate.

As shown in FIG. 2, a number of coating stations 14, 114 may be located in series to apply the same or a different coating material onto the substrate 18 at each coating station 14, 114. For example, it may be desirable to create a layered or stacked coating or to create a selected color on the substrate or to form multiple colors on the same substrate using the compositions and methods described in copending U.S. patent application Ser. No. 09/270,702 entitled “Compositions and Methods for Forming Coatings of Selected Color on a Substrate and Articles Produced Thereby”, which is herein incorporated by reference in its entirety.

Although the above discussion focused on the practice of the invention with a coating device utilizing conventional air atomizing spray nozzles, the invention is not limited to such coating devices but may be practiced with other types of coating devices, e.g., coaters for vapor depositing a coating (“CVD coaters”). As will be understood by one of ordinary skill in the CVD coating art, CVD coaters are usually located above a moving substrate. The coating block includes delivery slots through which coating material is discharged and one or more exhaust slots positioned transversely to a direction of movement of the substrate. A bottom 138 of a CVD type coating block 140 incorporating the principles of the present invention is shown in FIG. 5 and may, for example, be positioned in the forming chamber 50 of a float glass system 46 as shown by dashed lines in FIG. 3. As shown in FIG. 5, the CVD coating block 140 may have at least one tapered coating delivery slot 142, tapering from a narrower width at one end to a wider width at the other end, through which a coating material may be directed in conventional manner toward the surface of a substrate moving in the direction of arrow X under the coating block 140. Exhaust slots 144 are located on each side of the delivery slot 142. The exhaust slots 144 may be of uniform width as shown in FIG. 5 or may be tapered, e.g., in similar manner to the delivery slot 142. Alternatively, the delivery slot 142 may be of uniform width and the exhaust slots 144 tapered. A thicker coating will be applied to the substrate surface-under the narrower portion of the delivery slot 142 than under the wider portion of the delivery slot 142, with a graded coating thickness being deposited therebetween.

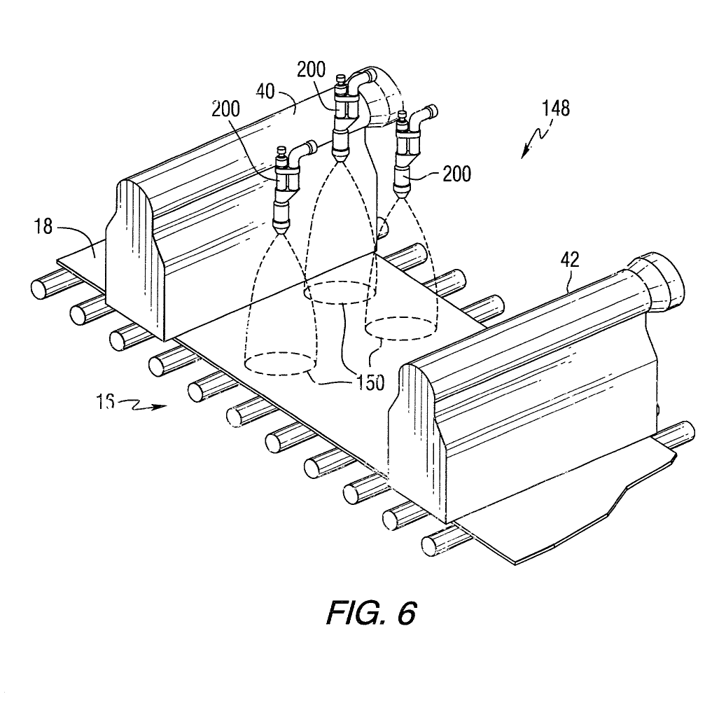

FIG. 6 shows a further embodiment of a coating station 148 of the invention. The coating station 148 has a first exhaust hood 40 spaced from a second exhaust hood 42 with a plurality of staggered, spaced apart coating dispensers 200, e.g., conventional air atomizing spray nozzles, located therebetween. In the embodiment shown in FIG. 6 but not to be considered as limiting to the invention, three such coating dispensers 200 are shown. The coating dispensers 200 are preferably movably or pivotally mounted on a stationary frame above a conveyor 16 used to transport a substrate 18 to be coated into the coating station 148. Of course, the coating dispensers 200 could alternatively be mounted on a movable frame or gantry to move the coating dispensers 200 relative to the substrate 18. The coating dispensers 200 are in flow communication with one or more sources of coating material and/or pressurized fluid.

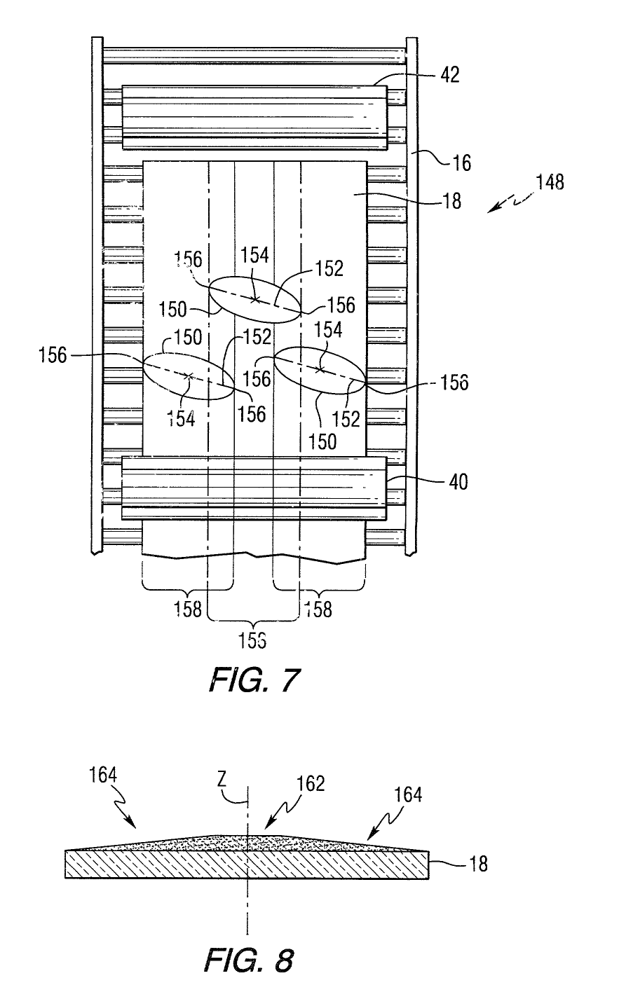

As shown in FIG. 6, the coating dispensers 200 are preferably directed downwardly toward the substrate 18 to form spray patterns, such as elliptical or elongated spray patterns 150, on the substrate 18. As shown in FIG. 7, each elongated pattern 150 has a major axis 152 with a center 154 and an outer periphery or edge 156. The coating dispensers 200 are arranged so that the spray pattern from one coating dispenser 200 does not interfere with the spray pattern from another coating dispenser 200, e.g., to prevent the sprays from the coating dispenser from interfering with one another. For example, the coating dispensers 200 may be arranged in a staggered formation such that the major axes 152 are all substantially parallel and are spaced apart. As shown in FIG. 7, each coating dispenser 200 forms a coated area 158 on the substrate 18 as the substrate 18 moves through the coating station 148. The coating dispensers 200 are preferably positioned such that the coated area 158 formed by one coating dispenser 20 does not extend beyond the pattern center 154 of an adjacent coating dispenser 200. Thus, the coated areas 158 overlap to form a coating as shown in FIG. 8 having a substantially uniformly thick center region 162 with tapered or graded side regions 164 located at each side of the coating. If desired, the coated substrate 18 may be cut into two or more pieces. For example, the substrate 18 may be cut in half along a vertical axis Z shown in FIG. 8 to form two separate coated pieces, with each piece having a graded side region 164 or the piece 18 may be cut into three pieces with the center piece having a uniform coating and the outer pieces having the graded region.

While in the embodiment discussed above coating dispensers 200 forming elliptical coating patterns were discussed, the invention is not limited to such elliptically shaped coating patterns. The coating patterns may, for example, be of any shape, e.g., circular, oval, etc. Additionally, a plurality of such coating stations 148 may be positioned in series to spray the same or different coating materials onto the substrate.

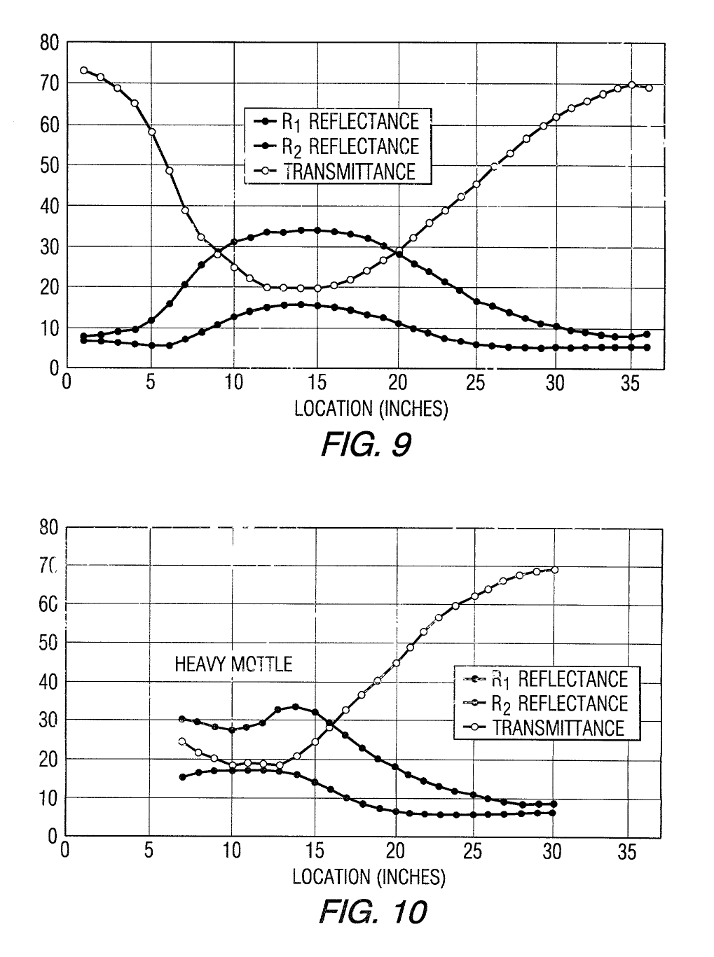

FIG. 9 shows the percent reflectance (“R₁”) from the coated surface; percent reflectance (“R₂”) from the uncoated surface and percent transmittance for a glass substrate coated in a coating station utilizing the principles of the invention. The coating station utilized was similar to the coating station 148 shown in FIG. 6 but had two coating dispensers 200, with one coating dispenser 200 laterally offset from the other by a distance of about 5 inches (12.7 cm). Pieces of flat glass (commercially available from PPG Industries, Inc. of Pittsburgh, Pa. under the registered trademark SOLEXTRA®) approximately 0.157 inch (4.0 mm) thick, 24 inches (60.1 cm) wide and 30 inches (76.2 cm) to 40 inches (101.6 cm) long, were sprayed with an aqueous suspension of a mixture of copper, cobalt and manganese acetylacetonates to pyrolytically deposit a coating onto the glass surface. The deposited coating had a maximum thickness of about 400-600 Å with tapered regions on each side of the coated glass piece. The percent reflectance R₁ and R₂, and percent transmittance were measured at selected positions across the coated glass from one tapered side or edge of the glass toward the other tapered side. The “O” position on the abscissa of FIG. 9 corresponds to one edge of the coated glass sheet, e.g., the left side, with the other abscissa positions indicating the distance from that edge at which percent reflectance R₁ and R₂ and transmittance values were measured. The coating had higher transmittance regions located at the sides of the substrate, i.e. at the tapered regions and a lower transmittance region located near the middle of the substrate 18, i.e., the thicker, central region with smoothly graduated transmittance areas therebetween; whereas, the coating had lower reflective R₁ and R₂ at the sides of the substrate and a higher reflectance near the middle of the substrate. The R₁ values were higher at each measurement than the R₂ values.

As discussed above, adjacent coating dispensers 200 should be positioned such that the spray pattern 150 from one coating dispenser 200 does not interfere with the spray pattern 150 from another coating dispenser 200. FIG. 10 shows the percent reflectance R₁ and R₂ and transmissions values for a coating applied similarly as described above but with the sprays from each of two adjacent coating dispensers 200 deposited in a line normal to the edge of the glass such that the adjacent sprays resulted in interference between the two spray patterns. The interference between the two spray patterns from the coating dispensers 200 formed a coating having a heavily mottled, non-uniformly thick center region. The reflectance and transmittance percentages were measured using standard C.I.E. Illuminant C, light 2 degree observer.

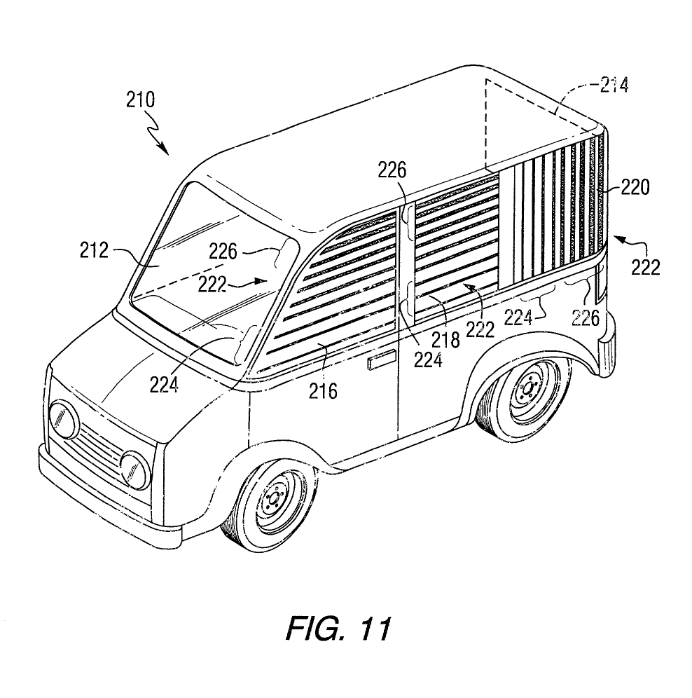

A vehicle 210 is generally shown in FIG. 11. The vehicle 210 includes a windshield 212, a rear window 214 and side windows 216, 218, and 220. For purposes of discussion, these will be collectively referred to simply as “windows”. Side windows 216 and 218 are formed from glass coated in accordance with the invention to form a graded fade zone 222 gradually varying from a thinly coated, substantially transparent first region 224 near the bottom to a more thickly coated, less transparent second region 226 near the top. In the preferred embodiment, the windows are installed in the vehicle 210 with the fade zones 222 oriented vertically, as shown with respect to side windows 216 and 218. However, as shown with respect to side window 220, the fade zone 222 can be oriented horizontally, if so desired. The fade zone 222 could also be oriented with the first region 224 at the top of the window, if so desired. Further, as described above with respect to the coating assembly 100 the fade zone 222 can be formed such that the first region 224 is of a first color and the second region 226 is of a different, second color by applying different coating materials during formation of the fade zone 222 in adjacent coating stations.

It will be readily appreciated by those skilled in the art that modifications may be made to the invention without departing from the concepts disclosed in the foregoing description. For example, in the preferred embodiments discussed above, the coating dispensers remain stationary while the substrate is moved on the conveyor. It is also within the scope of the invention to hold the substrate stationary and move the coating dispenser relative to the substrate or to move the substrate and coating dispenser relative to one another. Such modifications are to be considered as included within the scope of the invention. Accordingly, the particular embodiments described in detail hereinabove are illustrative only and are not limiting as to the scope of the invention, which is to be given the full breadth of the appended claims and any and all equivalents thereof.

We claim:

1. A method for forming a graded coating on a surface of a substrate having a first end and a second end, comprising the steps of:
positioning at least one first coating dispenser relative the first end of the substrate;
directing said first coating dispenser toward the substrate such that an axis extending through a delivery end of said first coating dispenser subtends a predetermined angle with the substrate; and
supplying a first coating material to said first coating dispenser such that the coating material is deposited onto the substrate to form a graduated coating on the substrate.

2. The method as claimed in claim 1, including heating the substrate such that the first coating material pyrolyzes on the substrate.

3. The method as claimed in claim 1, including positioning a first exhaust hood on one side of said first coating dispenser and positioning a second exhaust hood on the other side of said first coating dispenser.

4. The method as claimed in claim 1, including positioning at least one second coating dispenser spaced from said first coating dispenser and supplying a second coating material to said second coating dispenser.

5. The method as claimed in claim 4, including directing said second coating dispenser toward the substrate such that an axis extending through a delivery end of said second coating dispenser subtends a second predetermined angle with the substrate.

6. The method as claimed in claim 4, wherein the second coating material is different from the first coating material.

7. The method as claimed in claim 5, wherein the second predetermined angle is different from the first predetermined angle.

8. The method as claimed in claim 1 further including the step of displacing the first coating dispenser and substrate relative to one another.

9. An article of manufacture formed by the method of claim 1.

10. A method of forming a graded coating on a surface of a substrate, comprising the steps of:
providing a plurality of spaced coating dispensers, each coating dispenser configured to provide a spray pattern having a center on the substrate;
directing coating material through the coating dispensers; and
positioning the coating dispensers to form a plurality of overlapping coated areas on the substrate as the substrate moves relative to the coating dispensers to form a graded coating on the substrate.

11. The method as claimed in claim 10, including positioning the coating dispensers such that a coated area formed by one coating dispenser on the substrate does not extend beyond the center of the spray pattern of an adjacent coating dispenser.

12. The method as claimed in claim 10, wherein the spray patterns are elongated spray patterns having a major axis and the method includes positioning the coating dispensers such that the major axes of the coating dispensers are substantially parallel.

13. The method as claimed in claim 10, including positioning said coating dispensers such that the coating has a tapered region on each side of the coating.

14. The method as claimed in claim 13, including dividing the coated substrate into a plurality of pieces, each piece having a tapered region.

15. An article of manufacture formed by the method of claim 10.

16. An apparatus for forming a graded coating on a surface of a substrate, comprising:
a supporting surface;
at least one first coating dispenser having a delivery end;
a source of coating material in flow communication with said first coating dispenser;
at least one exhaust hood mounted in a spaced, predetermined relation to said first coating dispenser; and
means for mounting said first coating dispenser relative to said supporting surface, wherein no shield is located between said first coating dispenser and said support surface, and
wherein an axis extending through said delivery end subtends a predetermined angle with said supporting surface such that coating material is directed from said discharge end onto said substrate surface to form a graded coating on the substrate surface.

17. The apparatus as claimed in claim 16, further including a heated chamber, wherein said conveyor is configured to transport the substrate to be coated from said heated chamber to said first coating dispenser.

18. The apparatus as claimed in claim 16, including a second coating dispenser spaced from said first coating dispenser, with said second coating dispenser positioned to subtend a second predetermined angle with the supporting surface.

19. The apparatus as claimed in claim 16, wherein said predetermined angle is between about 20-40 .

20. The apparatus as claimed in claim 16, including a first exhaust hood and a second exhaust hood, with said first coating dispenser located between said first and second exhaust hoods.

21. The apparatus as claimed in claim 16, including means for causing relative movement between the substrate and said first coating dispenser.

22. The apparatus as claimed in claim 20, including a third exhaust hood and at least one second coating dispenser, wherein said second coating dispenser is located between said second and third exhaust hoods.

23. An apparatus for forming a graded coating on a surface of a substrate, comprising:
a tapered coating delivery slot having a first end and a second end, with a width of said delivery slot decreasing from said first end to said second end; and
at least one exhaust slot spaced from said tapered delivery slot.

24. The apparatus as claimed in claim 23, wherein said at least one exhaust slot is tapered.

25. An apparatus for forming a graded coating on a surface of a substrate, comprising:
a plurality of spaced coating dispensers, each configured to provide a spray pattern having a center to form a plurality of overlapping coated areas on the substrate as the substrate moves relative to said coating dispensers,
wherein said coating dispensers are positioned such that a coated area formed by one coating dispenser on the substrate does not extend beyond the center of the spray pattern of an adjacent coating dispenser.

26. The apparatus as claimed in claim 25, wherein each coating dispenser is configured to provide an elongated spray pattern having a major axis and wherein the major axes of said coating dispensers are substantially parallel.

27. An article of manufacture, comprising:
a substrate having a surface; and
a graded coating pyrolytically deposited on the surface of the substrate, the coating having varying thicknesses along a predetermined length of the coating.

28. The article of manufacture as claimed in claim 27, wherein the coating has a tapered region on each side of the coating.

29. The article of manufacture as claimed in claim 27, wherein the glass substrate is an architectural window or an automotive transparency.

30. A vehicle having a window with a coating pyrolytically deposited on a surface of the window to form a graded coating on the surface of the window.

31. The vehicle as claimed in claim 30, wherein the surface is an outer window surface.
